(19) United States
(12) Patent Application Publication
(10) Pub. No.: US 2025/0378345 A1
(43) Pub. Date: Dec. 11, 2025

(54) INFORMATION PROCESSING APPARATUS, TASK SOLUTION METHOD, AND PROGRAM

(71) Applicant: Panasonic Intellectual Property Management Co., Ltd., Osaka (JP)

(72) Inventors: Tomoyuki KAGAYA, Kanagawa (JP); Jing Yuan THONG, Singapore (SG); Yuxuan LOU, Singapore (SG); Jayashree KARLEKAR, Singapore (SG); Sugiri Pranata LIM, Singapore (SG); Akira KINOSE, Kanagawa (JP); Koki OGURI, Tokyo (JP); Felix Christopher WICK, Langen (DE)

(73) Assignee: Panasonic Intellectual Property Management Co., Ltd., Osaka (JP)

(21) Appl. No.: 18/918,810

(22) Filed: Oct. 17, 2024

(30) Foreign Application Priority Data
Jun. 11, 2024 (JP) 2024-094374

(51) Int. Cl. G06N 3/091

(52) U.S. Cl. CPC G06N 3/091

(57) ABSTRACT

An information processing apparatus including: an accessor that accesses a memory for storing, for each of a plurality of tasks, a successful process in solving the task as an example; and a solver that acquires an example similar to a solution process for a task to be solved from the memory, causes a large language model to perform learning of the example, and solves the task to be solved by using the large language model in which the learning has been performed.

### CROSS REFERENCE TO RELATED APPLICATIONS

This application is entitled and claims the benefit of Japanese Patent Application No. 2024-094374, filed on Jun. 11, 2024, the disclosure of which including the specification, drawings and abstract is incorporated herein by reference in its entirety.

### TECHNICAL FIELD

The present disclosure relates to an information processing apparatus, a task solution method, and a program.

### BACKGROUND ART

Large language models (LLMs) have attracted attention as a technology that can replace human actions and decision-making. For example, LLM is intended to be used to task solution in situations such as automatically running a system or automatically operating a robot.

There is a method called In-Context Learning, in which several examples are given to the LLM to solve a task. The example is, for example, a pair consisting of a task example and a solution example. The example is given to the LLM in a form included in a prompt that serves as an example of a solution to a task. By learning several examples given, LLM solves the task considering the context corresponding to the examples. In-Context Learning may be called Few-shot Learning.

### CITATION LIST

### Patent Literature

### PTL 1

Japanese Patent Application Laid-Open No. 2024-043563

### SUMMARY OF INVENTION

### Technical Problem

At present, it is not easy to prepare an appropriate example corresponding to the task to be solved. In a configuration where a user generates examples at any time, the accuracy of task solution becomes unstable, and a significant load is imposed on the user. Further, in a configuration where a determined (fixed) example is given to the LLM, the example is not necessarily suitable for the current task solution. For this reason, there is a problem in that LLM considers contexts that do not match the task to be solved, resulting in taking time to solve the task or failing to solve the task.

A non-limiting embodiment of the present disclosure contributes to the provision of an information processing apparatus, a task solution method, and a program each capable of appropriately solving a given task.

### Solution to Problem

An information processing apparatus according to an example embodiment of the present disclosure includes: an accessor that accesses a memory for storing, for each of a plurality of tasks, a successful process in solving the task as an example; and a solver that acquires an example similar to a solution process for a task to be solved from the memory, causes a large language model to perform learning of the example, and solves the task to be solved by using the large language model in which the learning has been performed.

A task solution method according to an example embodiment of the present disclosure includes: accessing a memory for storing, for each of a plurality of tasks, a successful process in solving the task as an example; and acquiring an example similar to a solution process for a task to be solved from the memory, causing a large language model to perform learning of the example, and solving the task to be solved by using the large language model in which the learning has been performed.

A non-transitory computer-readable recording medium storing therein a program according to an example embodiment of the present disclosure, the program causing a processor to perform processing, including: accessing a memory for storing, for each of a plurality of tasks, a successful process in solving the task as an example; and acquiring an example similar to a solution process for a task to be solved from the memory, causing a large language model to perform learning of the example, and solving the task to be solved by using the large language model in which the learning has been performed.

It should be noted that general or specific embodiments may be implemented as a system, a method, an integrated circuit, a computer program, a storage medium, or any selective combination thereof.

### Advantageous Effects of Invention

According to an embodiment of the present disclosure, a given task can be appropriately solved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating an example block configuration of information processing apparatus 1 according to an embodiment;

FIG. 2 is a diagram illustrating an outline of operation of information processing apparatus 1;

FIG. 3 illustrates an example block configuration of agent 2;

FIG. 4 illustrates an example of information stored in memory 3;

FIG. 5 is a diagram illustrating a prompt for generating an overall plan;

FIG. 6 is a diagram illustrating a prompt for generating a retrieval key;

FIG. 7 is a diagram illustrating retrieval of a past experience related to an action;

FIG. 8 is a diagram illustrating a prompt for generating an action;

FIG. 9 is a flowchart illustrating an example operation of information processing apparatus 1;

FIG. 10 is a diagram illustrating an example of text generation on a platform; and

FIG. 11 is a diagram illustrating an outline of operation of information processing apparatus 1 in a variation.

### DESCRIPTION OF EMBODIMENTS

Hereinafter, an embodiment of the present disclosure will be described in detail with reference to the accompanying drawings as appropriate. However, more detailed description than necessary may be omitted. For example, detailed descriptions of already well-known matters and repeated descriptions for substantially the same configuration may be omitted. This is to prevent the following description from becoming unnecessarily redundant and to facilitate understanding by those skilled in the art.

Note that, the accompanying drawings and the following description are provided so that those skilled in the art understand the present embodiment sufficiently, and are not intended to limit the subject matters recited in the claims.

### Block Configuration of Information Processing Apparatus

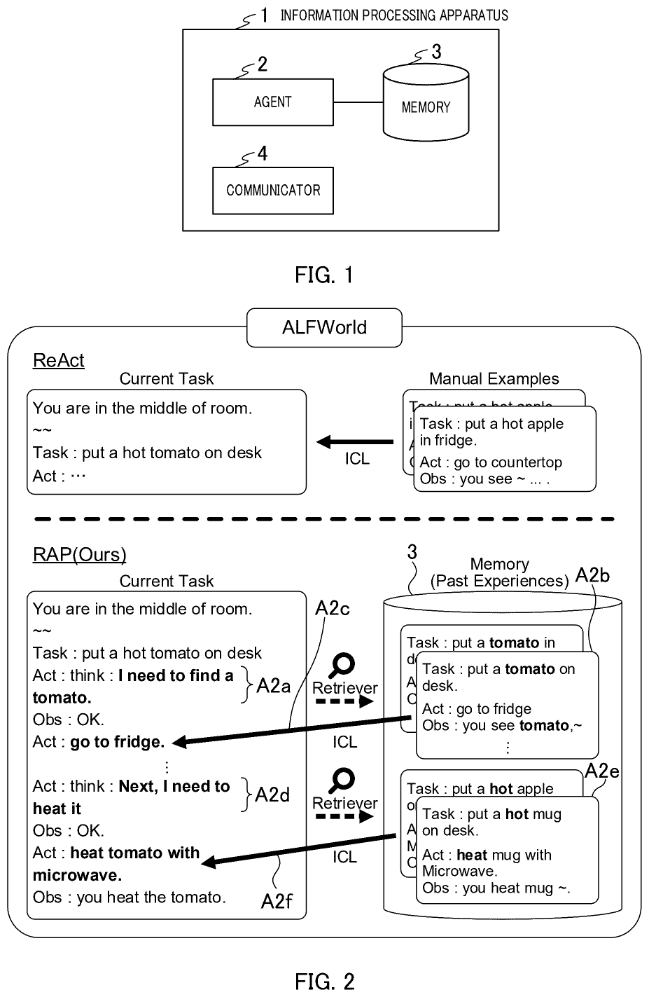

FIG. 1 is a diagram illustrating an example block configuration of information processing apparatus 1 according to an embodiment. As illustrated in FIG. 1, information processing apparatus 1 includes agent 2, memory 3, and communicator 4. Agent 2 may be referred to as an LLM, an LLM agent, or a controller. Information processing apparatus 1 may be, for example, a personal computer or a server.

Memory 3 stores programs such as operating system (OS) programs and application programs that agent 2 executes. Various data are also stored in memory 3. For example, memory 3 stores successful experiences (examples) in task solution. Here, the successful experience includes at least one or more pairs of examples of a task and a solution to this task.

Note that the successful experience may be a pair of a task that has been implemented or simulated in the past and a solution that has actually succeeded in solving the task, that is, a successful experience in past task solution. Further, the successful experience may include a pair of an example of a task and an example of a solution that the user has configured as correct, even though the user has not implemented or simulated the task in the past. In this manner, for example, for a task for which a user can easily imagine a solution, it is possible to generate a successful experience without performing the implementation or the simulation, and thus it is possible to expand variations of successful experiences to be stored in memory 3.

Memory 3 is constituted by, for example, a storage apparatus such as a hard disk drive (HDD), a solid state drive (SDD), a random access memory (RAM), a read only memory (ROM), and a flash memory.

Agent 2 is constituted by, for example, a processor such as a central processing unit (CPU) and/or a graphics processing unit (GPU). For example, the function of agent 2 is realized by executing a program stored in memory 3.

Agent 2 searches for (acquires) a successful experience according to the current situation from memory 3. Agent 2 learns the searched successful experience through In-context Learning (ICL) and solves the current task.

Communicator 4 communicates with other apparatuses through a network such as the Internet, for example.

### Operation Outline of Information Processing Apparatus

FIG. 2 is a diagram illustrating an outline of operation of information processing apparatus 1. FIG. 2 omits the illustration of agent 2 shown in FIG. 1. FIG. 2 illustrates memory 3 shown in FIG. 1.

The figure of “ReAct” illustrated in FIG. 2 is a diagram illustrating an operation of a conventional agent. The figure of “retrieval-augmented planning (RAP)” illustrated in FIG. 2 is a diagram illustrating the operation of agent 2 according to the present disclosure. An operation of a conventional agent on ALFWorld is also illustrated in FIG. 2.

Note that ALFWorld is a platform (simulator) for an agent to learn in a virtual 3D environment. The agent solves the given task while interacting in the environment of ALFWorld (refer to Current Task in FIG. 2). Since the inventors conducted an evaluation experiment of the present embodiment using ALFWorld, the present embodiment will be described below based on a simulation in the environment of ALFWorld. Note that, since ALFWorld is a simulator that reproduces characteristics identical to those of a real environment, the present embodiment operates effectively even when applied to a real environment.

A conventional agent learns determined examples (Manual Examples) using ICL, as illustrated in “ReAct” in FIG. 2, and leads to the solution of the current task.

Agent 2 of the present disclosure, as illustrated in “RAP” in FIG. 2, searches for (acquires) an experience corresponding to the current situation (for example, task, Act: think, and the like) from memory 3, in which a past successful experience (hereinafter, simply referred to as an experience or an example) is stored. Agent 2 learns the searched experience using ICL and leads the solution of the current task. The current situation can be regarded as a situation or a process (solution process) when leading to the solution of the task.

For example, agent 2 searches for (acquires) experience A2b similar to situation A2a illustrated in FIG. 2 from memory 3. Agent 2 learns searched experience A2b, that is, an example corresponding to current situation A2a, using ICL and leads the current task to the solution as indicated by arrow A2c.

For example, agent 2 searches for experience A2e similar to situation A2d illustrated in FIG. 2 from memory 3. Agent 2 learns the searched experience A2e, that is, an example corresponding to current situation A2d, using ICL, and leads the solution of the current task as indicated by arrow A2f.

As described above, agent 2 searches (calls) for a successful experience corresponding to the current situation from memory 3. Agent 2 learns the successful experience searched from memory 3, using ICL, and leads the solution of the current task. Through this operation, information processing apparatus 1 can appropriately solve the given task.

Note that the successful experiences searched from memory 3, as described later, may be two or more. For example, agent 2 may search for two or more successful experiences similar to situation A2a from memory 3. Agent 2 may learn two or more successful experiences searched using ICL and lead the current task to the solution.

### Block Configuration of Agent

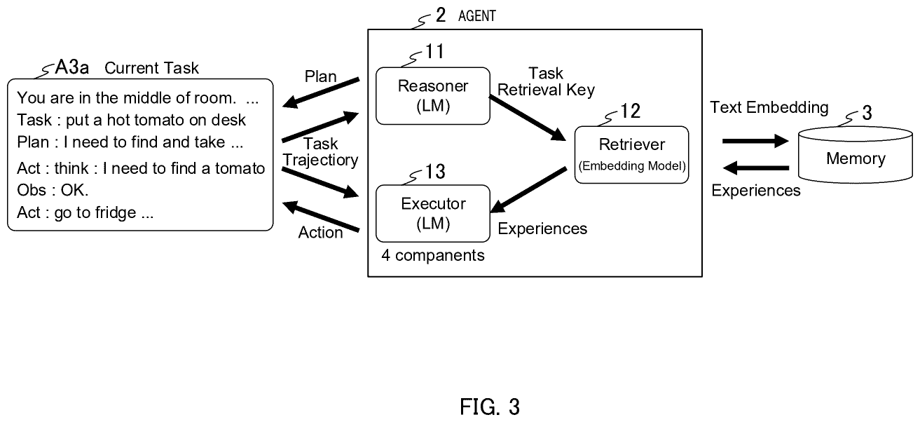

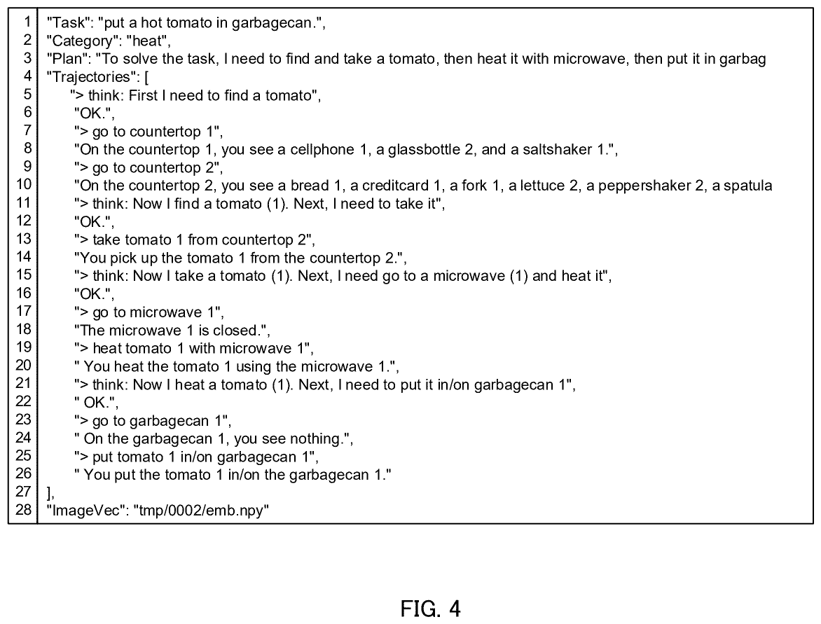

FIG. 3 illustrates an example block configuration of agent 2. As illustrated in FIG. 3, agent 2 includes reasoner 11, retriever 12, and executor 13. Reasoner 11 and the executor each include a language model (LM). LM is, for example, a large language model (LLM). FIG. 3 illustrates memory 3 and current task A3a on the platform such as ALFworld, in addition to the block of agent 2.

The first and second lines in current task A3a are tasks (challenges) given to agent 2 (information processing apparatus 1). The third, fourth, and sixth lines are outputs of agent 2. The fifth line is an output (response) of the platform (environment).

### (1) Memory

In memory 3, a successful experience is stored (as an example). The experience includes, for example, task-related information such as a task and an overall plan, and trajectory information such as an action plan, an action, and an observation (Obs).

The successful experience stored in memory 3 is, for example, a past successful experience and is a log of when agent 2 solved a task. That is, memory 3 stores a log of when agent 2 solved tasks in the past. The successful experience stored in memory 3 can be regarded as a successful process.

A user may manually generate a log of a task that has never been solved by agent 2 and store the log in memory 3 as a successful experience. Note that, in some cases in solving the task, there may be constraints that are difficult for a user to imagine. Therefore, a log of a task that agent 2 has actually solved may be more appropriate as a successful experience than a log set by the user's imagination. For that reason, when prioritizing accuracy, only tasks that agent 2 has solved in the past may be stored as successful experiences. On the other hand, in cases where the tasks that agent 2 has solved in the past are limited, the logs of the tasks are possibly not stored in memory 3, even if a content of a correct task is easily understood from the user's experience. When the variety of successful experiences stored in memory 3 is large, it becomes possible to refer to various successful experiences. Thus, in such cases, the user may be allowed to generate a log manually and store the log in memory 3 as an addition. Hereinafter, an example in which a past successful experience is used as a successful experience will be described. However, since the processing in the case of using a successful experience set by the user and the processing in the case of using a past successful experience are the same, a detailed description will be omitted.

FIG. 4 illustrates an example of a log stored in memory 3. A past successful experience (log) is stored in memory 3 in the format illustrated in FIG. 4. For example, one successful experience has a format such as Task, Category, Plan, and Trajectories, and is stored in memory 3. FIG. 4 illustrates an example in which a successful experience when a hot tomato is put on a garbagecan is stored, but various successful experiences are stored in memory 3.

Here, Task indicates a task that has been solved through a successful experience. Category indicates the classification of the task. Plan indicates a plan of a series of works performed to solve the task. Trajectories indicate a plan of action or an action performed to realize the plan. Note that the successful experience may not necessarily include all of this information. In the example described later, information included in Task, Plan, and Trajectories is utilized, but information in Category is not utilized, and accordingly, Category may be omitted.

The “Plan” illustrated in FIG. 4 may correspond to an overall plan. Here, the overall plan refers to a plan of a series of works necessary to solve the task. The overall plan stored in memory 3 may be referred to as a success plan.

The “think” illustrated in FIG. 4 may correspond to an action plan. Here, the action plan refers to a plan for action of the next steps to implement a part of the work of the overall plan.

The description with “>” without think in FIG. 4 (for example, the seventh line, ninth line, and the like in FIG. 4) may correspond to an action. Here, the action refers to an action actually performed on the simulator. Here, at the stage when the action plan is generated, the current situation such as the disposition of the object does not change. However, at the stage when the action is performed, the current situation changes.

The description in FIG. 4 that does not include “>” (for example, the descriptions in the sixth line, eighth line, and the like in FIG. 4) may correspond to Obs. Obs represents the evaluation result of the action plan by the platform or the observation result of the environment changed by the action. Obs may be regarded as an output of the platform.

### (2) Reasoner

Reasoner 11 generates an overall plan, an action plan, and a retrieval key.

### (2-1) Overall Plan

Reasoner 11 makes an overall plan (generates an overall plan) for task solution from task information. For example, reasoner 11 generates the overall plan from the “task” included in Current Task A3a in FIG. 3. Note that the task information may be conceived as information including a task and conditions related to the task (for example, see the first line to the third line in FIG. 10). In the present embodiment, the overall plan is generated by giving an instruction by a prompt including the task information to the large language model. The overall plan generated in accordance with the instruction of the prompt (large language model) may be referred to as a solution plan.

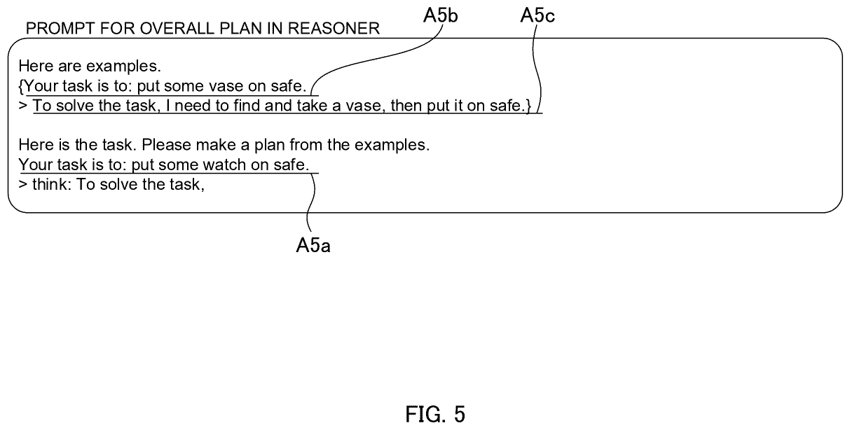

FIG. 5 is a diagram illustrating a prompt for generating the overall plan. Note that the prompt illustrated in FIG. 5 is different from Current Task A3a illustrated in FIG. 3. The prompt may be regarded as ICL and executor 13. The task indicated in underline A5a in FIG. 5 may correspond to, for example, “Task: put a hot tomato on desk” illustrated in Current Task A3a in FIG. 3.

Reasoner 11 acquires, via retriever 12, a similar task similar to the task indicated in underline A5a in FIG. 5 and the overall plan for the similar task from memory 3. Hereinafter, the processing of acquiring information similar to the specified information from memory 3 by using retriever 12 will also be referred to as retrieval. Reasoner 11 gives (inputs) the retrieved similar task and the overall plan for the similar task to the prompt.

For example, reasoner 11 retrieves, from memory 3, the similar task indicated in underline A5b in FIG. 5 that has been retrieved from memory 3 (a similar task similar to the task indicated in underline A5a) and the overall plan for the similar task indicated in underline A5b, and gives them to the prompt. That is, in order to solve the task indicated in underline A5a, reasoner 11 retrieves the example (texts indicated in underline A5b and A5c) from memory 3 and gives the prompt the example.

Note that, in the above, one example similar to the text indicated in underline A5a is retrieved from memory 3, but the present disclosure is not limited to this. Reasoner 11 may retrieve the top n examples from memory 3, which are similar to the text indicated in underline A5a. Reasoner 11 may give the retrieved top n examples to a prompt. By giving an appropriate number of examples to the prompt, the task indicated in underline A5a may be appropriately solved.

Further, the retrieval of the similar task and the overall plan for the similar task is actually executed by retriever 12. For example, retriever 12 includes an Embedding Model that performs processing of vectorizing a text, uses a method called embedding to vectorize the text (token) described in “task,” and calculates similarity in between with the text (vectorized text) in “task” stored in memory 3. The similarity is evaluated, for example, using the cosine similarity between vectorized texts. Retriever 12 retrieves a text with a high similarity (similar task) and the overall plan of the similar task from memory 3.

Here, the high similarity indicates, for example, that the similarity is equal to or greater than a predetermined threshold. Note that the determination criterion for whether the similarity is high is not limited to this. For example, if the similarity is within a predetermined rank from the top, the similarity may be determined to be high. Further, when the similarity is equal to or greater than a predetermined threshold and is within a predetermined rank from the top, it may be determined that the similarity is high. Note that a high degree of similarity is also expressed as “similar”. Reasoner 11 gives the retrieved similar task and the overall plan to the prompt.

### (2-2) Action Plan

The action plan indicates a plan of action to be taken next (see “Act:think: . . . ” in FIG. 3). Reasoner 11 generates the action plan for the action generation of executor 13, which will be described later.

For example, reasoner 11 generates the action plan based on a task or a response (Obs) from a platform. The generated action plan is given to executor 13 (ICL) and serves as a basis for the action generation of executor 13.

### (2-3) Retrieval Key

The retrieval key is a keyword corresponding to the current situation. Reasoner 11 gives a determined example (Manual Example) to a prompt and generates a retrieval key based on (relevant to) the content of the action plan using a large language model.

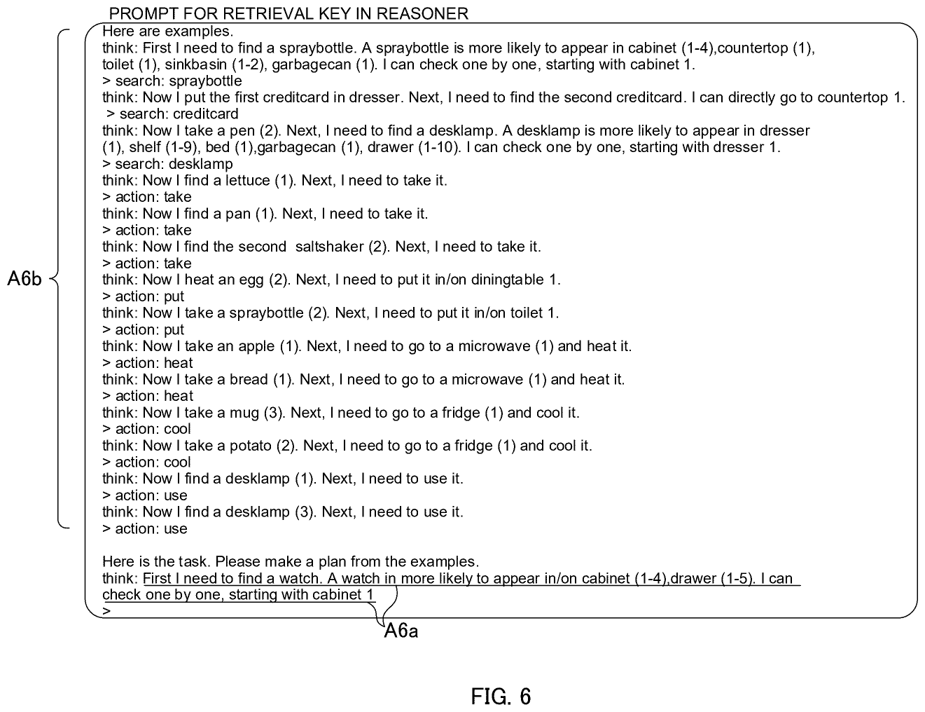

FIG. 6 is a diagram illustrating a prompt for generating a retrieval key. In order to generate a retrieval key based on the content of the action plan (think) indicated in underline A6a in FIG. 6, reasoner 11 gives the example illustrated in region A6b in FIG. 6 to a prompt.

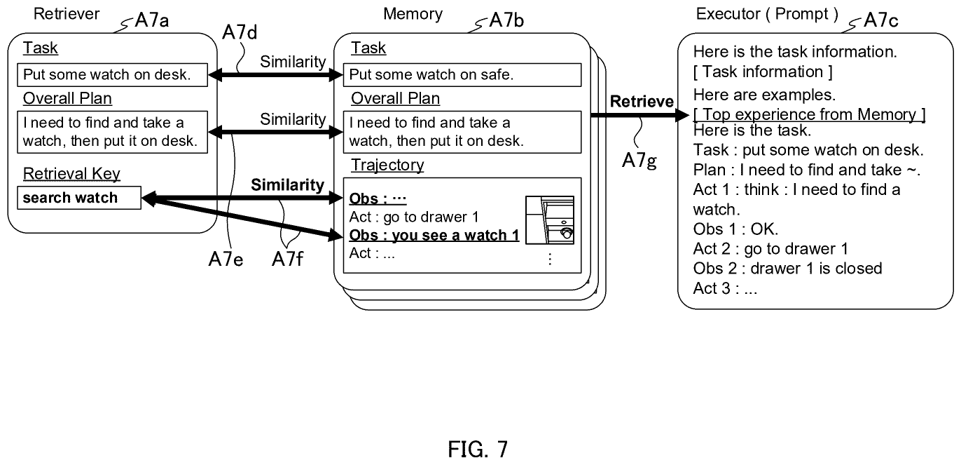

Reasoner 11 generates an appropriate retrieval key for the action plan indicated in underline A6a through learning of the example illustrated in region A6b in FIG. 6. For example, in the action plan indicated in underline A6a, reasoner 11 generates a retrieval key such as “watch”. Reasoner 11 outputs the generated retrieval key to a current task (see, for example, frame A7a in FIG. 7 or the seventh line in FIG. 10).

Note that the example (fixed example) for acquiring a retrieval key is not limited to one. A plurality of examples may be given to acquire a retrieval key.

Further, a case where the retrieval key is generated by giving a prompt including a predetermined example to the large language model has been described here, but the retrieval key may be generated by a more simplified method. For example, the retrieval key may be generated by extracting words that appear frequently in the action plan or by causing the large language model to summarize the action plan without giving the example to the prompt.

### (3) Retriever

Retriever 12 retrieves the similar task and the overall plan for a similar task from memory 3, as described in “(2-1) Overall Plan” above.

Further, retriever 12 retrieves an experience (past experience) related to an action from memory 3, based on the task information and the retrieval key.

FIG. 7 is a diagram illustrating retrieval of a past experience related to an action. Frame A7a illustrated in FIG. 7 indicates the current task. Frame A7b indicates one experience of the plurality of experiences stored in memory 3. Frame A7c indicates a prompt.

Retriever 12 calculates the similarity between the text of “Task” in the current task and the text of “Task” stored in memory 3, as indicated by arrow A7d in FIG. 7.

Retriever 12 calculates the similarity between the text of “Overall Plan” in the current task and the text of “Overall Plan” stored in memory 3, as indicated by arrow A7e in FIG. 7.

Retriever 12 calculates the similarity between the “Retrieval Key” in the current task and the text of “trajectories” stored in memory 3, as indicated by arrow A7f in FIG. 7.

Note that, as the method of calculating the similarity, the method described in “2-1 Overall Plan” above may be used.

Retriever 12 retrieves, for example, one experience most similar, based on the total sum of similarities described above, from memory 3. The experience retrieved by retriever 12 is given to a prompt (executor 13) as indicated by arrow A7g in FIG. 7.

In the above, one experience is retrieved from memory 3, but a plurality of experiences with high similarities may be retrieved from memory 3. For example, the top k experiences with the high similarity may be retrieved from memory 3. The retrieved top k experiences may be given to the prompt as examples. By giving an appropriate number of examples to the prompt, an appropriate action may be generated.

### (4) Executor

Executor 13 generates the next action based on the task information and past experiences. Further, if the action plan is generated, executor 13 also considers the action plan when generating the next action.

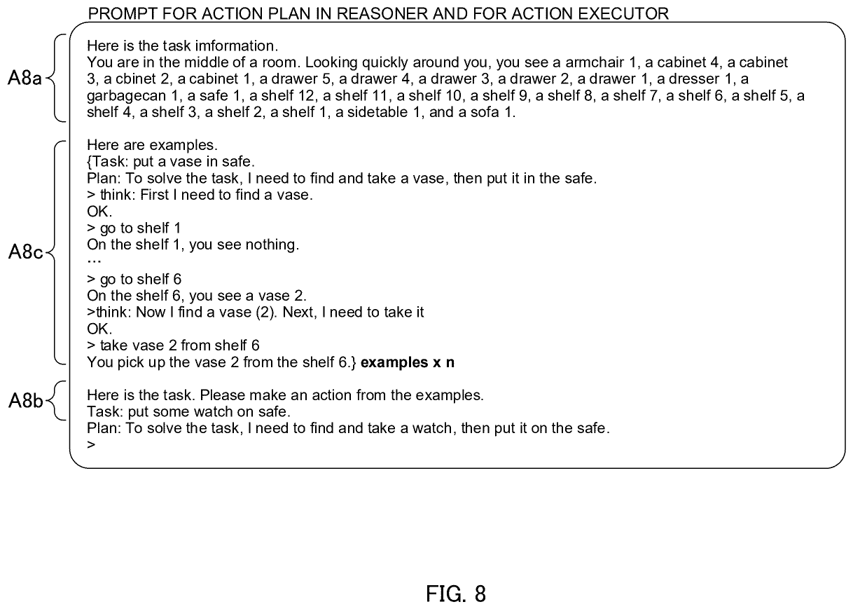

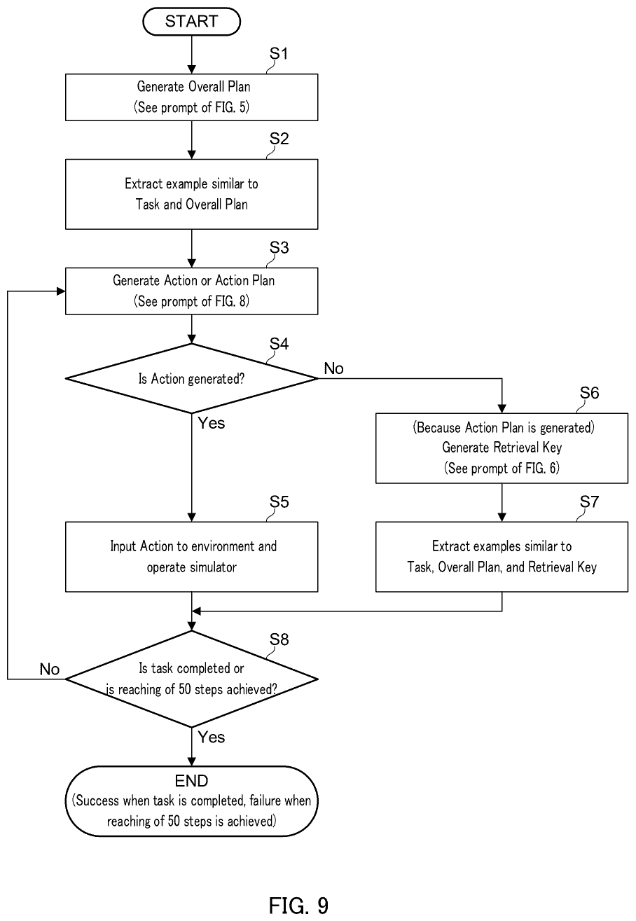

FIG. 8 is a diagram illustrating a prompt for generating an action. Executor 13 inputs the task information into the prompt as illustrated in regions A8a and A8b in FIG. 8. Executor 13 inputs a past experience retrieved by retriever 12 into the prompt as illustrated in region A8c in FIG. 8. For example, Executor 13 may input n past experiences into the prompt. Thus, an action is generated (not illustrated).

The past experience illustrated in region A8c in FIG. 8 may correspond to “Top experience from Memory” indicated by arrow A7g in FIG. 7.

The functional block of agent 2 illustrated in FIG. 3 is an example. The function in agent 2 of learning a given example and solving a task may be referred to as a solver. The function in agent 2 of accessing memory 3 may be referred to as an accessor.

### Operation Flow

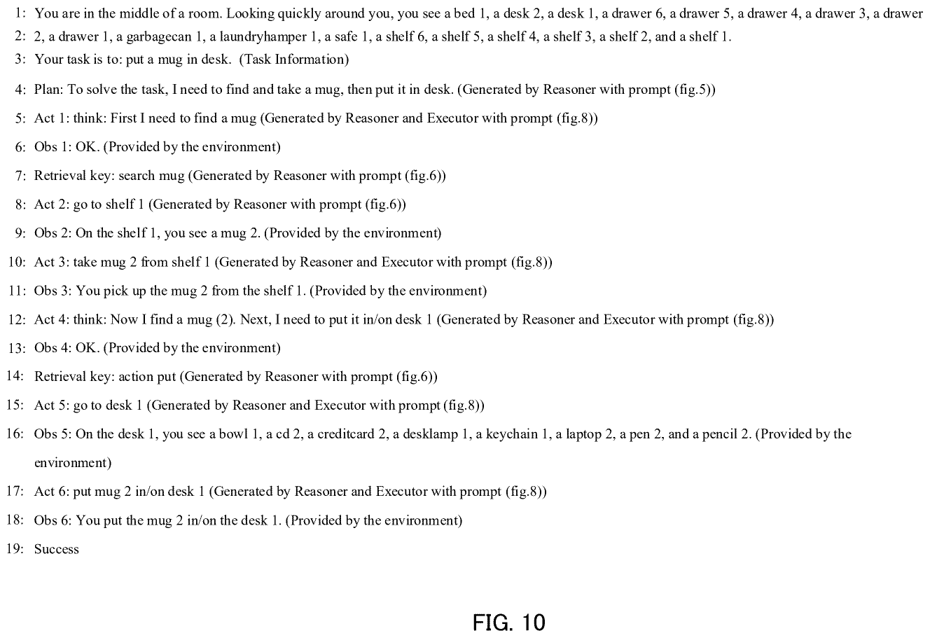

FIG. 9 is a flowchart illustrating an example operation of information processing apparatus 1. It is assumed that information processing apparatus 1 is given with the task information (see the first line to the third line of FIG. 10).

Information processing apparatus 1 generates an overall plan (S1). For example, information processing apparatus 1 retrieves, as described in FIG. 5, a similar task similar to the given task and the overall plan for the similar task from memory 3. Information processing apparatus 1 gives the retrieved similar task and the overall plan thereof as an example in a prompt, and generates the overall plan.

Information processing apparatus 1 retrieves (extracts) an example (past experience) similar to the task and the overall plan from memory 3 (S2).

Information processing apparatus 1 generates an action or an action plan based on the example extracted in S2 or the example extracted in S7 described later (past experience) (S3). For example, information processing apparatus 1 generates an action or an action plan by giving the example extracted in S2 or the example extracted in S7 to the prompt as described in FIG. 8.

Information processing apparatus 1 determines whether the action is generated (S4).

In a case where the action is generated (S4: Yes), information processing apparatus 1 inputs the action to the environment (current task) and operates a framework (simulator) such as ALFWorld (S5). Thus, the current situation of the simulator changes.

In a case where no action is generated (S4: No), in other words, in a case where an action plan is generated, information processing apparatus 1 generates a retrieval key (S6). For example, information processing apparatus 1 generates a retrieval key related to the current action plan by giving a determined example to the prompt as described in FIG. 6. That is, information processing apparatus 1 generates a retrieval key corresponding to the current situation.

When the retrieval key is generated in S6, information processing apparatus 1 extracts examples similar to the task, the overall plan, and the retrieval key from memory 3 (S7). For example, information processing apparatus 1 calculates the similarity of each of the task, the overall plan, and the retrieval key, as described in FIG. 7, and retrieves the most similar one or more examples based on the total sum of the calculated similarities.

After the simulator is operated in S5 or the example is extracted in S7, information processing apparatus 1 determines whether the task has been completed or whether the generation of the text in the current task has reached a predetermined number of steps (for example, 50 steps) (S8). Note that the number of steps is not limited to 50. Since the number of steps is a condition for determining that the task has failed to be solved as described later, the number of steps may be changed as appropriate depending on how strictly the failure is evaluated.

In a case where the task is not completed and the reaching of 50 steps is also not yet achieved (S8: No), information processing apparatus 1 proceeds the processing to S3.

On the other hand, in a case where the task is completed or the reaching of 50 steps is achieved, information processing apparatus 1 ends the processing in the flowchart in FIG. 9. Note that, in a case where the reaching of 50 steps is achieved while the task is not completed, information processing apparatus 1 may output an error indicating that the task has failed to be solved.

### Example of Text Generation

FIG. 10 is a diagram illustrating an example of text generation on a platform. When information processing apparatus 1 is operated on the platform of ALFWorld, the text illustrated in FIG. 10 is generated as an example. Note that the texts in FIG. 10 within parentheses are for describing an example of text generation and is not texts generated on the platform.

The first line to the third line of FIG. 10 are task information. The fourth line is generated, for example, by the processing of S1 in FIG. 9. The fifth line is generated, for example, by the processing of S3. The seventh line is generated, for example, by the processing of S4 (No) and S6. The eighth line is generated by, for example, the processing of S7, S8 (No), and S3. The tenth and twelfth lines are generated, for example, by the processing of S4 (Yes), S8 (No), and S3. The fourteenth line is generated by, for example, the processing of S4 (No) and S6. The fifteenth line is generated by, for example, the processing of S7, S8 (No), and S3. The seventeenth line is generated by, for example, the processing of S3. The fourth and subsequent lines may be considered as a solution process or decision-making process for solving the task information.

### Summary of Embodiment

Information processing apparatus 1 learns from the given example and solves the task. Information processing apparatus 1 acquires and learns an example corresponding to a solution process of the task from memory 3, which stores successful processes from past task solutions as examples. According to this operation, information processing apparatus 1 can retrieve an example (successful experience) corresponding to the current situation for learning and can solve a given task appropriately.

### Variations

In the above, operations of information processing apparatus 1 in a text environment have been described, but information processing apparatus 1 can also be applied to a multimodal environment (text+image). In a variation, the text described in the above embodiments is replaced with the text and image (picture).

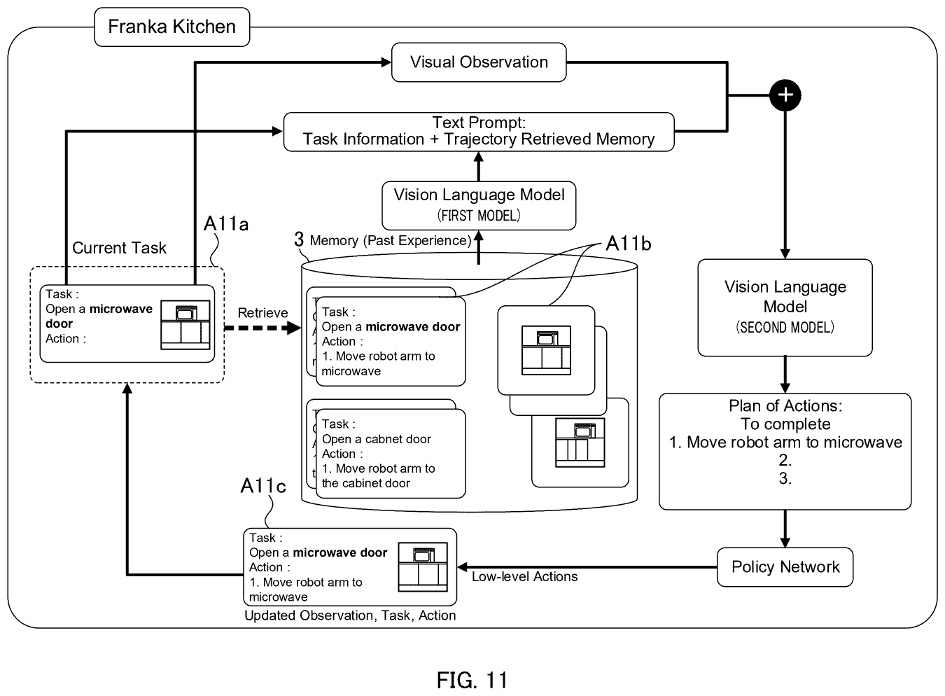

FIG. 11 is a diagram illustrating an outline of operation of information processing apparatus 1 in a variation. In FIG. 11, memory 3 shown in FIG. 1 is illustrated. Further, in FIG. 11, the illustration of agent 2 shown in FIG. 1 is omitted. FIG. 11 illustrates an operation of agent 2 according to the present disclosure on Franka Kitchen.

Note that Franka Kitchen is a platform (simulator) for an agent to learn to operate a robot with 9 degrees of freedom in a kitchen environment equipped with household items.

Agent 2 searches for an experience (text and image) corresponding to the current situation from memory 3, where text and image of past successful experiences are stored. Agent 2 learns the searched experience using a Vision Language Model (VLM) and leads to the solution of the current task.

For example, agent 2 searches for experience A11b similar to situation A11a illustrated in FIG. 11 from the memory. Agent 2 learns the searched experience A11b, that is, an example corresponding to current situation A11a, using a vision language model and leads to the solution of the task as illustrated in frame A11c.

Here, the vision language model may include a first model that converts natural language text and image into a single embedding space and a second model that receives inputs of natural language text (prompt) and image and generates a text.

By using the first model, it is possible to compare the text and image corresponding to the current situation with the text and image included in a past successful experience in the same embedding space and to calculate the similarity taking into account the text and image comprehensively. Thus, it is possible to select a successful experience for learning that takes into account both text and image comprehensively. Further, by using the second model, it is possible to generate an action or an action plan from the description of image and a task. Accordingly, the second model can be learned using the successful experience selected using the first model, and an action or an action plan can be generated from the image and the task corresponding to the current situation using the second model. Note that CLIP and similar models are known as the first model, and CPT-4V, LLaVA, and similar models are known as the second model. Therefore, a detailed description of each model will be omitted.

Further, in the vision language model, either the first model or the second model may be omitted.

In a case where the first model is omitted, for example, experience A11b similar to situation A11a may be searched based on a similarity between a text part included in situation A11a and a text part of a successful experience stored in memory 3. In this case, the procedure for searching for the successful experience becomes the same as the operation of the retriever of information processing apparatus 1 in a text environment.

Further, in a case where the second model is omitted, it is sufficient to have ICL learn the text part among the text and image included in the selected successful experience. The specific operations in this case are the same as those in information processing apparatus 1 in a text environment, and thus a detailed description will be omitted.

Further, the similarity that takes into account both text and images comprehensively may be calculated by using the second model. For example, an image included in situation A11a and images of successful experiences stored in memory 3 may be converted into natural language texts by the second model, and experience A11b may be searched based on the similarity between these texts. At this time, if situation 11a or a successful experience includes a text, this text may also be used to search for experience A11b.

As described above, agent 2 searches for a successful experience corresponding to the current situation from memory 3. Agent 2 learns the searched successful experience using a vision language model and leads the solution of the current task. Through this operation, information processing apparatus 1 can appropriately solve the given task.

### Other Variation

In the above-described embodiment, the successful experience to be used as an example is selected based on the similarity between tasks when generating the overall plan, and is selected based on the similarity between the retrieval key corresponding to the current situation and the trajectories of the successful experience when generating the action or the action plan. However, the successful experience used as an example may be selected based on the similarity evaluated in other combinations. For example, a successful experience may be selected based on the similarity between the retrieval key corresponding to the current situation and a task of the successful experience, or a successful experience may be selected based on the similarity between a task to be solved and the trajectories of the successful experience. Further, in a case where an image is stored as a successful experience as in the variation, the successful experience to be used as an example may be selected based on the similarity between the text information, such as the task or the retrieval key, and the image included in the successful experience. In this case, the similarity may be evaluated after converting an image included in the successful experience into a text or into a vector corresponding to the text using a vision language model. Further, in the embodiment described above, a successful experience may be selected using information on a category included in the successful experience. In this case, a category corresponding to a task to be solved or the current situation is estimated based on any of the task, the overall plan, or the retrieval key, and thus, the similarity in between with the category included in the successful experience may be compared. In this case, a large language model may be used to propose a category from the task, the overall plan, or the retrieval key, and this category may be used as the category of the task to be solved or the current situation. Further, the similarity between any of the task, the overall plan, or the retrieval key and the category included in the successful experience may be evaluated directly.

Further, the similarity may be evaluated as the sum of the similarities between the tasks, the overall plans, and the retrieval keys, and the tasks, the overall plans, and the trajectories of a successful experience. In this case, for example, the similarities between tasks, between overall plans, and between retrieval keys and trajectories may be calculated as cosine similarities, respectively, and the sum of these similarities may be treated as the similarity between the task to be solved or its solution process and the task or the successful process stored as a successful experience.

Further, text or image may be recorded or used in a format available to information processing apparatus 1. That is, as long as the information indicates text or image, the data may be in a format that a human cannot recognize as text or image. In this case, information processing apparatus 1 may use text or image in a format that is unrecognizable by a human without converting the text or image into a format recognizable by a human. Note that both a format recognizable by a human and a format unrecognizable by a human are collectively referred to as information indicating a text or information indicating an image.

The description has been given of an embodiment with reference to the drawings, but the present disclosure is not limited to the examples. It is apparent that variations or modifications in the category described in the claims may be conceived of by a person skilled in the art. It is to be understood that such variations or modifications fall within the technical scope of the present disclosure. In addition, component elements in the embodiment may be optionally combined without departure from the spirit of the present disclosure.

In the embodiment described above, the term such as “part” or “portion” or the term ending with a suffix such as “-er” “-or” or “-ar” may be replaced with another term, such as “circuit (circuitry),” “assembly,” “device,” “unit,” or “module.”

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

### Industrial Applicability

The present disclosure is useful for task solution in situations such as automatically moving a system or automatically operating a robot.

### Reference Signs List

1 Information processing apparatus
2 Agent
3 Memory
11 Reasoner
12 Retriever
13 Executor

1. An information processing apparatus, comprising:
an accessor that accesses a memory for storing, for each of a plurality of tasks, a successful process in solving the task as an example; and
a solver that acquires an example similar to a solution process for a task to be solved from the memory, causes a large language model to perform learning of the example, and solves the task to be solved by using the large language model in which the learning has been performed.

2. The information processing apparatus according to claim 1, wherein the solver causes the large language model to perform learning of the example by causing a prompt that instructs the large language model to solve the task to be solved to include the acquired example.

3. The information processing apparatus according to claim 2, wherein the solver selects the successful process similar to the solution process as an example to be learned by the large language model.

4. The information processing apparatus according to claim 3, wherein the solver generates information indicating a keyword related to the solution process and acquires, as an example, a successful process including information indicating a text similar to the information indicating the keyword from the memory.

5. The information processing apparatus according to claim 3, wherein the solver acquires a plurality of examples from the memory in order starting from an example that is most similar to the solution process.

6. The information processing apparatus according to claim 1, wherein:
the memory further stores a successful plan in solving each of the plurality of tasks, and
the solver is configured to:
cause a large language model to perform learning of a successful plan for a task similar to the task to be solved and generate a solving plan for the task to be solved using the large language model in which the learning has been performed; and
acquire an example similar to a solution process for the task to be solved from the memory, cause the large language model to perform learning of the example, and generate the solution process by using the large language model in which the learning has been performed.

7. The information processing apparatus according to claim 1, wherein:
the memory stores, as an example, a successful process including at least information indicating a text, and
the solver learns an example of the information indicating the text and solves the task.

8. The information processing apparatus according to claim 7, wherein:
the memory stores, as an example, a successful process including the information indicating the text and information indicating an image, and
the solver learns an example of the information indicating the text and the information indicating the image and solves the task.

9. A task solution method, comprising:
accessing a memory for storing, for each of a plurality of tasks, a successful process in solving the task as an example; and
acquiring an example similar to a solution process for a task to be solved from the memory, causing a large language model to perform learning of the example, and solving the task to be solved by using the large language model in which the learning has been performed.

10. A non-transitory computer-readable recording medium storing therein a program, the program causing a processor to perform processing comprising:
accessing a memory for storing, for each of a plurality of tasks, a successful process in solving the task as an example; and
acquiring an example similar to a solution process for a task to be solved from the memory, causing a large language model to perform learning of the example, and solving the task to be solved by using the large language model in which the learning has been performed.
